(19) United States
(12) Patent Application Publication
(10) Pub. No.: US 2012/0167389 A1
(43) Pub. Date: Jul. 5, 2012

(54) METHOD FOR PROVIDING A FILM COOLED ARTICLE

(75) Inventors: Benjamin Paul LACY, Greer, SC (US); Jane M. LIPKIN, Niskayuna, NY (US); Michael J. SULLIVAN, Simpsonville, SC (US)

(73) Assignee: GENERAL ELECTRIC COMPANY, Schenectady, NY (US)

(21) Appl. No.: 12/984,115

(22) Filed: Jan. 4, 2011

(51) Int. Cl. B23P 6/00; B23P 17/00

(52) U.S. Cl. 29/889.1; 29/402.18

(57) ABSTRACT

A method for providing a film cooled article is disclosed. A metallic article is provided having first and second wall surfaces and a cooling hole. The cooling hole includes a metering hole that extends from an inlet at the second wall surface to an outlet at the first wall surface. The method further includes exposing the first wall surface of the metallic article, applying a thermal barrier coating overlying the first wall surface and at least partially covering the outlet, boring through an outer surface of the applied thermal barrier coating to expose the metering hole, removing the thermal barrier coating from a trough portion of the outlet formed in the metallic article and forming a trough region in the thermal barrier coating that extends from the trough portion of the outlet formed in the metallic article to be flush with the outer surface of the thermal barrier coating.

### FIELD OF THE INVENTION

The present invention is directed to methods of providing a film cooled article and more particularly to providing such an article having cooling holes with complex outlet shapes.

### BACKGROUND OF THE INVENTION

In a gas turbine engine, air is pressurized in a compressor and mixed with fuel in a combustor for generating hot combustion gases. Energy is extracted from the gases in a high pressure turbine which powers the compressor, and in a low pressure turbine which powers an external shaft for industrial and marine applications or which powers a fan in a turbofan aircraft engine application.

During operation of gas turbine engines, the temperatures of combustion gases may exceed 1650° C. (3000° F.), considerably higher than the melting temperatures of the metal parts of the engine which are in contact with these gases. Operation of these engines at gas temperatures that are above the metal part melting temperatures is a well established art, and depends in part on supplying a cooling air to the outer surfaces of the metal parts through various methods. Metal parts that are particularly subject to high temperatures include those forming combustors and parts located aft of the combustor.

Thin metal walls of high strength superalloy metals are typically used for enhanced durability while minimizing the need for cooling thereof. Various cooling circuits and features are tailored for these individual components in their corresponding environments in the engine, but all these components typically include rows of film cooling holes, which have become increasingly complex in design.

Metal temperatures can also be maintained below melting levels by using thermal barrier coatings. Although thermal barrier coatings are commonly used to protect the metallic substrate of an article, the presence of the thermal barrier coating can present particular difficulty with the maintenance and repair of such articles. The thermal barrier coating may gradually wear away over time and/or may be removed to re-expose the substrate during repair operations. When a thermal barrier coating is re-applied prior to returning the article to service, the thermal spray process can result in covering the cooling holes and in the case of complex-shaped cooling holes, also obscuring those complex shapes and rendering the features of those shapes ineffective.

A method to reveal underlying complex shaped cooling holes following application of a newly applied thermal barrier coating that maintains performance and also in a way that does not damage the article or the newly applied thermal barrier coating is desirable in the art.

### SUMMARY OF THE INVENTION

A method of providing a film cooled article is disclosed that comprises providing a metallic article having a first wall surface and a second wall surface and having a cooling hole formed therein, the cooling hole comprising a metering hole extending from an inlet at the second wall surface to an outlet at the first wall surface; exposing the first wall surface of the metallic article; applying a thermal barrier coating overlying the first wall surface and at least partially covering the outlet formed therein; boring through an outer surface of the applied thermal barrier coating to expose the metering hole; removing the thermal barrier coating from a trough portion of the outlet formed in the metallic article; and forming a trough region in the thermal barrier coating that extends from the trough portion of the outlet formed in the metallic article to be flush with the outer surface of the thermal barrier coating.

According to one exemplary embodiment, the method comprises providing a gas turbine engine component having a first wall surface and a second wall surface and having a cooling hole formed therein, the cooling hole comprising a metering hole extending from an inlet at the second wall surface to a chevron shaped outlet at the first wall surface, the component previously having been in service; exposing the first wall surface of the component by stripping remnants of a previously applied first thermal barrier coating; applying a second thermal barrier coating overlying the first wall surface and the chevron shaped outlet formed therein; boring through an outer surface of the second thermal barrier coating to expose the metering hole; removing the second thermal barrier coating from a trough portion of the chevron shaped outlet; and forming a trough region in the second thermal barrier coating extending from the trough portion of the chevron shaped outlet until flush with the outer surface of the second thermal barrier coating, wherein each of the steps of boring, removing and forming are accomplished with a water jet or a laser.

One advantage of exemplary embodiments is that a process is provided by which parts having complex shape cooling holes can be refurbished, allowing for the repair and reuse of parts that might otherwise be scrapped in place of new-make parts.

Another advantage is that the cooling holes can be manufactured and operated at their intended design dimensions and do not need to be oversized to accommodate the possibility that thermal barrier coating overspray from a later repair operation might lead to smaller effective dimensions for the cooling hole. The use of oversized cooling holes can lead to reduced performance, which is avoided through the use of exemplary embodiments.

Yet another advantage is that the cooling holes do not need to be plugged prior to thermal barrier coating application to prevent overspray from lodging therein. The use of plugs can be time consuming and can result in damage to the thermal barrier coating when the plugs are subsequently removed.

Other features and advantages of the present invention will be apparent from the following more detailed description of exemplary embodiments, taken in conjunction with the accompanying drawings which illustrate, by way of example, the principles of the invention.

### BRIEF DESCRIPTION OF THE DRAWINGS

FIG. 1 illustrates a top view of an article having complex-shape cooling holes following application of a thermal barrier coating in accordance with an exemplary embodiment of the invention.

FIGS. 2 through 5 illustrate a cross-section of the complex-shape cooling hole at various stages of a process in accordance with an exemplary embodiment.

FIG. 6 illustrates a top view of the article of FIG. 1 following re-construction of the complex-shape cooling house in accordance with an exemplary embodiment of the invention.

### DETAILED DESCRIPTION OF EXEMPLARY EMBODIMENTS

Exemplary embodiments are directed toward methods for providing a film cooled article that includes removing discrete regions of a thermal barrier coating applied overlying articles having cooling holes with a complex shape, and particularly for the repair and reconstruction of such film-cooled articles. By complex shape is meant the cooling hole has an outlet formed with one or more engineered features to direct cooling air to achieve a pre-determined pattern of film cooling and includes, without limitation, chevron, diffuser and trench style cooling holes.

A metallic article is provided having cooling holes on a first wall surface that forms the outer boundary of a suitable cooling circuit provided in the article to receive air bled from the compressor in any conventional manner. In cases where the article is a component of a gas turbine engine, such as a nozzle or a bucket, the article is typically constructed of a nickel-base, cobalt-base or other base superalloy, although any metallic material may be used.

A metallic surface of the article is exposed to which a thermal barrier coating will be applied. In most cases, the article will have previously been in service and exposing the metallic surface of the article will entail stripping remnants of a previously applied thermal barrier coating from the metallic surface in any suitable manner. After the previously applied thermal barrier coating is stripped and the metallic surface of the article substrate is exposed, the article can be inspected and may be the subject of one or more repairs.

Following inspection and any associated repairs, but prior to returning the article to surface, a thermal barrier coating is applied overlying the metallic surface of the article. The thermal barrier coating may be applied by any suitable process, and is usually accomplished by a thermal spray process, such as air plasma spray, for example.

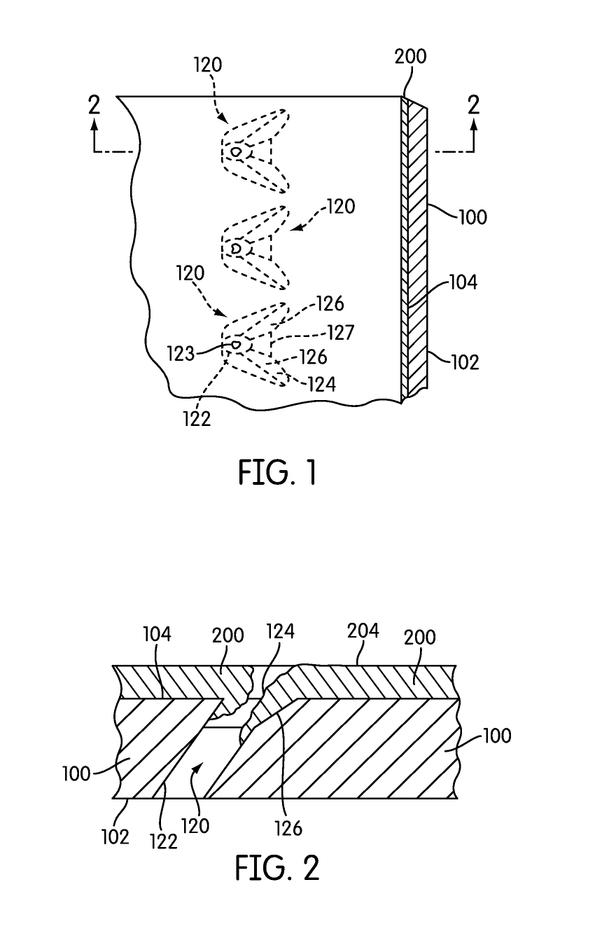

Referring now to FIG. 1, a metallic article 100 has one or more cooling holes 120 that extends from a complex shape outlet 124 at a first wall surface 104 of the article 100 to a second wall surface 102 of the article 100 such that air bled from the compressor can be transmitted from an inlet formed in the second wall surface 102 through the cooling hole 120 to provide film cooling to the first wall surface 104 of the article 100. In FIG. 1, the article 100 is shown following any inspection and/or repair and the subsequent application of a newly applied thermal barrier coating 200. As such, the cooling holes 120 underlying the thermal barrier coating 200, which are not readily visible, are shown in broken line for ease of illustration.

As illustrated in FIG. 1, a complex shape cooling hole 120 is formed having a cooling hole outlet 124 in the shape of a chevron, with multiple cooling holes 120 arranged in a suitable row along the applicable span of the article 100. Each of the cooling holes 120 includes a metering hole 122 that provides a substantially constant flow area from the inlet in the second wall surface 102 to the cooling hole outlet 124 in the first wall surface 104. From the metering hole 122, the cooling hole 120 transitions to the cooling hole outlet 124 that expands into a pair of chevron or wing-like troughs 126 or recesses that open outwardly toward, and become flush with, the first wall surface 104 of the article 100.

The two trough portions 126, as illustrated, are bridged by a ridge 127 that may be centered on the metering hole 122. It will be appreciated however, that particular features and their relative dimensions may vary without deviating from the overall chevron shape of the cooling hole outlet 124, nor are exemplary embodiments limited to use with cooling holes 120 having chevron shaped cooling hole outlets 124. Rather, exemplary embodiments can be used with any complex shape cooling hole arrangement.

The application of the thermal barrier coating 200 results in overspray that at least partially covers the cooling hole 120, including some of the thermal barrier coating material partially filling or even completely blocking the metering hole 122 that would reduce or prevent cooling area from reaching the cooling hole outlet 124. Application of the thermal barrier coating 200 also results in obscuring the complex features of the cooling hole outlet 124, including the trough portions 126 that slope away from the metering hole 122 toward the first wall surface 104. As FIG. 1 also illustrates, after the thermal barrier coating 200 has been applied, the coverage may be so thorough that only an irregularly shaped outline 123 of the metering hole 122 may remain visible.

The thermal barrier coating 200 may be applied to any desired thickness, but typically is applied to a thickness in the range of about 125 microns to about 1525 microns (about 0.005 in. to about 0.060 in.). In some embodiments, the thermal barrier coating 200 may be two or more layers having differing compositions and in some cases may include a bond coat followed by a ceramic top coat. For example, a layer of MCrAlY (in which M is Fe, Co, Ni or a combination) or other material may be applied as a bond coat, followed by a ceramic top coat, such as yttria stabilized zirconia (YSZ). It will be appreciated that such compositions are exemplary only and that any compositions as are known to those of ordinary skill for use with thermal barrier coatings may also be employed.

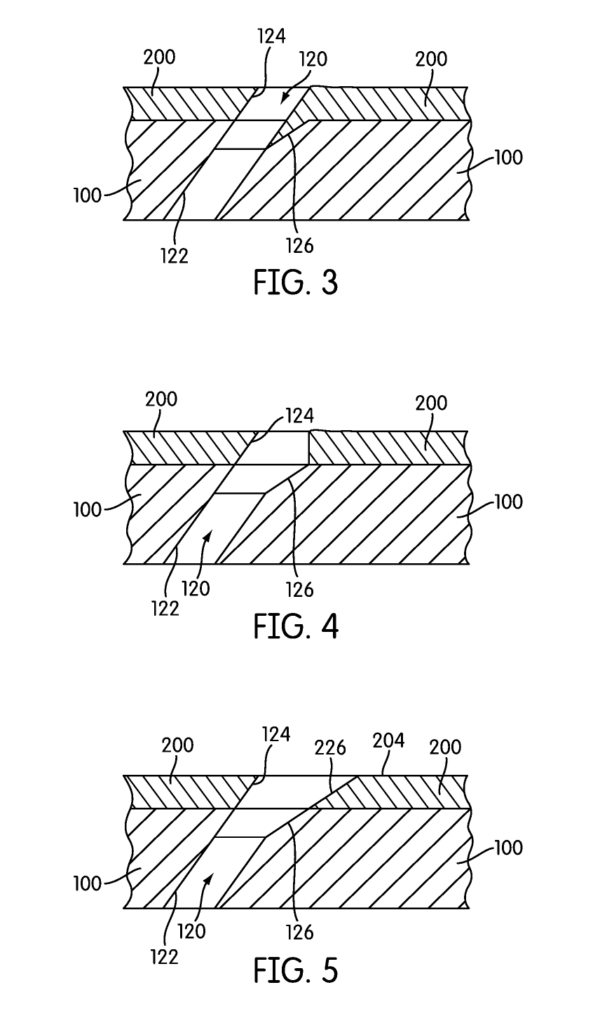

Turning to FIG. 2, a cross-sectional view of the article 100 of FIG. 1 is shown, i.e., after application of the new thermal barrier coating 200, but prior to re-opening of the cooling hole 120. FIG. 2 illustrates in cross-section the manner in which some of the thermal barrier coating material applied during the thermal spray process has settled in the metering hole 122. It further illustrates the manner by which the application of the thermal barrier coating material fills and thus obscures the complex features formed in the cooling hole outlet 124, including the trough portion 126.

The interior dimensions (i.e. the diameter) of the metering hole 122 may depend upon the particular article 100 with which the cooling holes 120 are employed and the volume of air to be delivered from the inlet at the second wall surface 102 for film cooling of the article 100. As illustrated, however, overspray from the application of the thermal barrier coating 200 can result in the effective dimensions of the metering hole 122 being significantly less after a repair. However, because processes carried out in accordance with exemplary embodiments result in substantially clearing the metering hole 122 of overspray, the cooling holes 120 can be constructed in accordance with intended design dimensions without subsequent limitations on operation or the need to produce oversized cooling holes that can lead to reduced performance.

Re-establishing the cooling hole 120 includes boring through an outer surface of the thermal barrier coating 200 to expose the metering hole 122, revealing the obscured outlet features, including the trough portions 126, and forming a trough in the thermal barrier coating 200 itself to form part of the cooling hole outlet 124. Although exemplified in a particular order as shown in the sequential FIGS. 3 through 5, the steps can be carried out in any order.

Each of the steps to remove thermal barrier coating material and re-establish the cooling holes 120 can independently be accomplished through the use of a tool such as a water jet or laser. In some cases, a mechanical bit or other device may also be used as the removal tool. Particularly in cases in which a water jet or laser is used as the removal tool, it may be desirable to continue to use the same tool for each step. In some cases, the tool may be electronically controlled by a computer for greater precision in accomplishing the removal steps.

Turning to FIG. 3, the cooling hole 120 is shown after the tool has been used to clear the metering hole 122 of extraneous thermal barrier coating material. Removal of the thermal barrier coating material from the metering hole 122 substantially restores its original internal dimensions. In some cases, it may be desirable to use a light to illuminate and thereby more easily identify the metering hole 122 prior to boring, particularly in those cases in which application of the thermal barrier coating 200 has resulted in a complete or nearly complete obfuscation of the underlying cooling hole 120.

Once the metering hole 122 has been re-opened, it can be used as a guide to remove thermal barrier coating overspray from other parts of the cooling hole outlet 124 based on the known dimensions of the cooling hole 120 and/or the orientation of the article 100. The tool can thus be used to reveal the trough portion 126 and other features of the complex shape cooling hole outlet 124 that had been obscured following application of the thermal barrier coating 200.

FIG. 4 illustrates a cross-sectional view after the tool has been used to clear away excess thermal barrier coating material from the trough portion 126 of the cooling hole outlet 124 subsequent to reopening of the metering hole 122. It will be appreciated that in some embodiments, the trough portion 126 may be removed first, with the trough edges used as a guide to identify and remove thermal barrier coating material from the metering hole 122, as well as from the remaining regions of the trough portions 126.

As seen in FIG. 4, the added thickness of the thermal barrier coating 200 overlying the substrate may result in an abrupt directional change in the region at which the trough portion 126 formed in the article 100 itself joins the first wall surface 104 of the article 100. In order to provide a smoother transition, the thermal barrier coating removal tool may also be used to form a trough region 226 in the thermal barrier coating 200 that essentially serves to extend the trough portion 126 formed in the article 100 until the recesses formed thereby are flush with the exposed surface 204 of the thermal barrier coating 200. In this manner, features formed in the thermal barrier coating 200 itself provide a portion of the cooling hole outlet 124 in the article 100. A cross-sectional view following formation of the thermal barrier coating trough region 226 is illustrated in FIG. 5, in which the cooling hole 120 has been fully reopened and the cooling hole outlet 124 re-established.

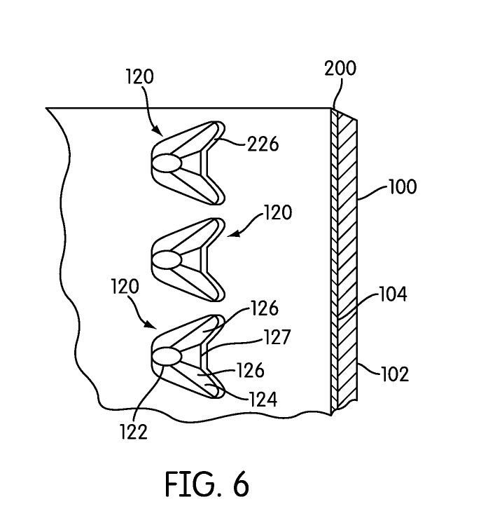

FIG. 6 illustrates the article 100 of FIG. 1 following re-establishment of the cooling holes 120, in which the cooling hole outlets 124 are now fully revealed, along with the continuation of the trough portion 126 into trough regions 226 formed in the thermal barrier coating 200.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for providing a film cooled article comprising:
providing a metallic article having a first wall surface and a second wall surface and having a cooling hole formed therein, the cooling hole comprising a metering hole extending from an inlet at the second wall surface to an outlet at the first wall surface;
exposing the first wall surface of the metallic article;
applying a thermal barrier coating overlying the first wall surface and at least partially covering the outlet formed therein;
boring through an outer surface of the applied thermal barrier coating to expose the metering hole;
removing the thermal barrier coating from a trough portion of the outlet formed in the metallic article; and
forming a trough region in the thermal barrier coating that extends from the trough portion of the outlet formed in the metallic article to be flush with the outer surface of the thermal barrier coating.

2. The method of claim 1, wherein the step of providing a metallic article comprises providing a gas turbine engine component.

3. The method of claim 1, wherein the step of providing a metallic article comprises providing the metallic article selected from the group consisting of a turbine nozzle and a turbine bucket.

4. The method of claim 1, wherein the step of providing a metallic article comprises providing the metallic article having a cooling hole with a chevron shaped outlet.

5. The method of claim 1, wherein at least one of the steps of boring, removing or forming is accomplished with a water jet.

6. The method of claim 1, wherein at least one of the steps of boring, removing or forming is accomplished with a laser.

7. The method of claim 1, wherein each of the steps of boring, removing and forming is accomplished with a water jet.

8. The method of claim 1, wherein each of the steps of boring, removing and forming is accomplished with a laser.

9. The method of claim 1, wherein the step of providing a metallic article comprises providing a metallic article that has previously been in service and wherein the step of exposing comprises stripping remnants of a previously applied thermal barrier coating from the first wall surface of the metallic article.

10. The method of claim 1, wherein the step of applying comprises applying the thermal barrier coating to a thickness in the range of about 0.010 in. to about 0.040 in.

11. The method of claim 1, wherein the step of applying a thermal barrier coating to the first wall surface comprises applying a bond coat on the first wall surface of the metallic article and applying a ceramic top coat on the bond coat.

12. The method of claim 1, wherein the step of boring is carried out prior to the step of removing.

13. The method of claim 12, further comprising using the uncovered metering hole to provide a guide for carrying out the step of removing.

14. The method of claim 1, wherein the step of removing is carried out prior to the step of boring.

15. The method of claim 1, further comprising using a light to identify a location of the at least partially covered outlet prior to the step of boring.

16. A method for providing a film cooled article comprising:
providing a gas turbine engine component having a first wall surface and a second wall surface and having a cooling hole formed therein, the cooling hole comprising a metering hole extending from an inlet at the second wall surface to a chevron shaped outlet at the first wall surface, the component previously having been in service;
exposing the first wall surface of the component by stripping remnants of a previously applied first thermal barrier coating;
applying a second thermal barrier coating overlying the first wall surface and the chevron shaped outlet formed therein;
boring through an outer surface of the second thermal barrier coating to expose the metering hole;
removing the second thermal barrier coating from a trough portion of the chevron shaped outlet; and
forming a trough region in the second thermal barrier coating extending from the trough portion of the chevron shaped outlet until flush with the outer surface of the second thermal barrier coating,
wherein each of the steps of boring, removing and forming are accomplished with a water jet or a laser.

17. The method of claim 16, wherein the gas turbine engine component is a turbine nozzle or a turbine bucket.

18. The method of claim 16, wherein the step of applying a second thermal barrier coating comprises applying the second thermal barrier coating to a thickness in the range of about 0.005 in. to about 0.060 in.

19. The method of claim 16, wherein the step of applying a second thermal barrier coating comprises applying a bond coat on the first wall surface of the component and applying a ceramic top coat on the bond coat.

20. The method of claim 16, wherein the step of removing the second thermal barrier coating from the trough portion of the chevron shaped outlet is carried out after the step of boring to expose the metering hole.
